(19) United States
(12) Patent Application Publication
(10) Pub. No.: US 2026/0132080 A1
(43) Pub. Date: May 14, 2026

(54) LITHIUM SLAG-BASED COMPOSITE CEMENTITIOUS MATERIAL AND PREPARATION METHOD THEREOF

(71) Applicant: Institute of Process Engineering, Chinese Academy of Sciences, Beijing, (CN)

(72) Inventors: Huiquan LI, Beijing (CN); Jianbo ZHANG, Beijing (CN); Yiyang LI, Beijing (CN); Shaopeng LI, Beijing (CN)

(21) Appl. No.: 19/383,406

(22) Filed: Nov. 7, 2025

(30) Foreign Application Priority Data
Nov. 8, 2024 (CN) 202411587117.4

(51) Int. Cl. C04B 18/14; C04B 22/14; C04B 28/02; C04B 28/04; C04B 28/06

(52) U.S. Cl. CPC C04B 18/144; C04B 22/143; C04B 28/021; C04B 28/04; C04B 28/06

(57) ABSTRACT

A lithium slag-based composite cementitious material and a preparation method thereof are disclosed, which relate to the field of composite materials. The preparation method of a lithium slag-based composite cementitious material in the present disclosure includes the following steps: S100, mixing lithium slag with an inorganic acid solution and then performing an activation treatment to obtain an activated material, wherein the components of the lithium slag include aluminosilicate and calcium oxide; S200, mechanically mixing an alkaline substance with the activated material to obtain a modified material having a pH value of 7 to 10, and then drying the modified material to obtain a modified powder; and S300, pulverizing the modified powder and an auxiliary material to obtain the lithium slag-based composite cementitious material.

### PRIORITY CLAIM AND CROSS-REFERENCE

This application claims the benefit of Chinese Application No. 202411587117.4, filed on Nov. 8, 2024, which application is expressly incorporated by reference herein in its entirety.

### TECHNICAL FIELD

The present disclosure relates to the field of composite materials, and specifically to a lithium slag-based composite cementitious material and a preparation method thereof.

### BACKGROUND

Lithium slag is produced during the extraction of lithium salt products from lithium ores such as lepidolite and spodumene. Lithium slag is not only difficult to dispose of but also prone to cause major pollution incidents. However, lithium slag is rich in elements such as aluminum, silicon, calcium and the like, and mainly exists in the form of anorthite and amorphous phase. Therefore, it can be used as an important raw material for preparing cementitious materials.

Currently, when using lithium slag to prepare the cementitious materials, not only is a large amount of activators required to activate the reactivity of the lithium slag, but also a significant quantity of auxiliary materials must be incorporated. This results in relatively high production costs for the cementitious material, and the compressive strength of the produced cementitious material is also low, making it unsuitable as a substitute for the cement.

### SUMMARY

An embodiment of the present disclosure provides a lithium slag-based composite cementitious material and a preparation method thereof. The preparation method of the present disclosure is relatively low-cost, and the produced lithium slag-based composite cementitious material also exhibits high compressive strength.

In a first aspect, an embodiment of the present disclosure provides a preparation method of a lithium slag-based composite cementitious material. It includes the following steps: S100, mixing lithium slag with an inorganic acid solution and then performing an activation treatment to obtain an activated material, wherein the components of the lithium slag comprise aluminosilicate and calcium oxide; S200, mechanically mixing an alkaline substance with the activated material to obtain a modified material having a pH value of 7 to 10, and then drying the modified material to obtain a modified powder; and S300, pulverizing the modified powder and an auxiliary material to obtain the lithium slag-based composite cementitious material.

In the preparation method of the present disclosure, the inventor finds that during mixing the lithium slag with the inorganic acid solution and then performing the activation treatment in step S100, the inorganic acid solution can react with the lithium slag, so that inert aluminosilicate can be activated and depolymerized to generate active aluminate and silicate, which can improve the pozzolanic activity of the lithium slag. Moreover, impurity elements such as aluminum, calcium, and the like in the lithium slag can also be utilized in situ as retarders and activators. Consequently, the reactivity of the lithium slag can be improved without the need for additional activators. After obtaining a powdered activated material, the activated material and the alkaline substance are mixed in step S200. The alkaline substance serves two purposes: first, it can neutralize excess hydrogen ions in the activated material, resulting in a modified material that is overall neutral or weakly alkaline; second, it can further promote the deep dissociation of aluminosilicate. Therefore, adding the alkaline substance in step S200 can enhance the stability of the cementitious system, and further promote the reactivity of the lithium slag. Finally, the auxiliary material and a dried modified material are pulverized. Since elements such as aluminum, silicon, sulfur, calcium, and the like in the system have been inductively activated, the modified material exhibits high reactivity. Consequently, the lithium slag-based composite cementitious material with high compressive strength can be formed without requiring a large amount of the auxiliary material.

In one possible implementation, based on the mass of the lithium slag, the mass content of aluminum oxide in the aluminosilicate is in the range of 10% to 20%, the mass content of silicon dioxide in the aluminosilicate is in the range of 30% to 60%, and the mass content of the calcium oxide is in the range of 5% to 30%.

In one possible implementation, the lithium slag includes at least one of lepidolite smelting slag or spodumene smelting slag.

In the above-mentioned technical solution, the lithium slag may be lepidolite smelting slag or spodumene smelting slag, which is advantageous for environmental protection.

In one possible implementation, the preparation method of the lithium slag-based composite cementitious material satisfies at least one of the following conditions: (1) the inorganic acid in the inorganic acid solution includes at least one of sulfuric acid or nitric acid; (2) the concentration of hydrogen ion in the inorganic acid solution ranges from 5 mol/L to 36 mol/L; and (3) the mass of the inorganic acid solution accounts for 5% to 20% of the mass of the lithium slag.

In the above-mentioned technical solution, the inorganic acid solution effectively activates the lithium slag, such that the lithium slag has higher reactivity, thereby facilitating the production of the lithium slag-based composite cementitious material with high compressive strength.

In one possible implementation, the activation treatment is performed using a mechanical activation method.

In the above-mentioned technical solution, the use of the mechanical activation enables the thorough mixing of the lithium slag and the inorganic acid solution, thereby further enhancing the reactivity of the lithium slag.

In one possible implementation, the alkaline substance includes at least one of carbide slag, steel slag, magnesium slag, calcium hydroxide, or sodium hydroxide.

In one possible implementation, the step of mechanically mixing of the alkaline substance with the activated material sequentially includes a first mechanical mixing and a second mechanical mixing; the rotational speed of the first mechanical mixing ranges from 100 r/min to 200 r/min, with a duration of 60 min to 90 min, and the mass of the alkaline substance added accounts for 5% to 20% of the mass of the lithium slag; and the rotational speed of the second mechanical mixing ranges from 250 r/min to 400 r/min, with a duration of 30 min to 60 min, and the mass of the alkaline substance added accounts for 2% to 4% of the mass of the lithium slag.

In the above-mentioned technical solution, the first mechanical mixing process can neutralize excess protonic acids, causing a mixture with neutral or weakly alkaline. It can also generate mineral phases such as calcium sulfate, aluminum sulfate, and the like, providing the active raw material for the subsequent formation of cementitious mineral phases such as ettringite, calcium silicate hydrate, and the like. The second mechanical mixing process can further decompose undissociated aluminosilicate in the lithium slag to form active aluminate and silicate, thereby enhancing the activity of the modified lithium slag and increasing the incorporation ratio of the lithium slag, which can prevent the consumption of the activators generated during the activation treatment process.

In one possible implementation, the auxiliary material includes at least one of slag, clinker, fly ash, or gypsum; and/or the mass of the auxiliary material added accounts for 40% to 60% of the mass of the lithium slag.

In the above-mentioned technical solution, the amount of the auxiliary material added is relatively low, which can effectively reduce preparation costs without compromising the compressive strength of the product.

In one possible implementation, the preparation method of the lithium slag-based composite cementitious material satisfies at least one of the following conditions: (1) the gypsum includes at least one of desulfurized gypsum, anhydrite, phosphogypsum, or fluorogypsum; (2) the fly ash includes at least one of fluidized bed fly ash or pulverized coal furnace fly ash; and (3) the clinker includes at least one of Portland clinker, aluminate clinker, or sulfoaluminate clinker.

In a second aspect, the present disclosure provides a lithium slag-based composite cementitious material prepared by the above-mentioned preparation method of the lithium slag-based composite cementitious material.

In the above-mentioned technical solution, the obtained lithium slag-based composite cementitious material exhibits high product compressive strength. Furthermore, its compressive strength conforms to a corresponding regression equation, enabling to adjust a material parameter to obtain a desired mechanical property.

The beneficial effects of the present disclosure are as follows:

The preparation method provided in the present disclosure utilizes the lithium slag as the raw material. By employing protonic acid activation coupled with mechanical processing, it achieves the depolymerization and activation of the inert aluminosilicate, thereby generating the active aluminate and silicate. This approach not only enhances the pozzolanic activity of the lithium slag, but also enables the in-situ utilization of the impurity elements such as aluminum and calcium to form aluminum-calcium based chemical activators, thereby addressing the problem of low reactivity in the lithium slag. By adding calcium-based solid waste in batches, on one hand, it neutralizes excess sulfuric acid to ensure the stability of the cementitious system; on the other hand, it further promotes the deep dissociation of the aluminosilicate to enhance reactivity, thereby achieving a stable cementitious system and a significant increase of the reactivity of the lithium slag. Finally, by adding fly ash, gypsum, slag, and clinker in batches, the system achieves induced activation of the elements such as aluminum, silicon, sulfur, calcium, and the like to form the cementitious material. The obtained lithium slag-based composite cementitious material can meet the requirements for Grade 52.5 and even Grade 62.5 cement when tested according to standard methods. Concurrently, it eliminates the consumption of the alkali activators, thereby substantially reducing the consumption of the clinker and the cement, shortening the process flow, and lowering manufacturing costs.

### DESCRIPTION OF THE DRAWINGS

To clearly describe the technical solutions in the embodiments of the present disclosure, the accompanying drawings used in describing the embodiments are briefly introduced below. Apparently, the accompanying drawings described below are merely some embodiments of the present disclosure. Those of ordinary skills in the art may derive other drawings from these accompanying drawings without creative efforts.

FIG. 1 is a process flow diagram according to embodiments of the present disclosure.

### DETAILED DESCRIPTION

In order to make the objects, technical solutions and advantages of the embodiments of the present disclosure clearer, the technical solutions of the present disclosure are described clearly and completely below. For those without giving specific conditions in the embodiments, they are carried out according to the conventional conditions or the conditions recommended by the manufacturer. Reagents or instruments that are used, for which no manufacturers are specified, are conventional products available commercially.

Currently, lithium slag generated during the extraction of lithium from special lithium ores such as lepidolite or spodumene can be utilized as a key material for cementitious materials. For example, Chinese Patent CN117756487B discloses a lithium slag cementitious material and a preparation method thereof, which involves mixing lithium slag, cement, and the like to produce the lithium slag cementitious material. Chinese Patent CN106116189B also discloses a method for preparing a clinker-free lithium slag composite cementitious material. However, in the current process for preparing cementitious material, it is often necessary to add a large amount of the activators to activate the lithium slag, while also requiring the incorporation of significant amount of the auxiliary material. This results in high production costs for the cementitious material, and furthermore, the produced cementitious material exhibits low compressive strength, making them unsuitable as a substitute for the cement.

To address the above-mentioned technical problem, the present disclosure provides a lithium slag-based composite cementitious material and a preparation method thereof. The content of the present disclosure is specifically described below.

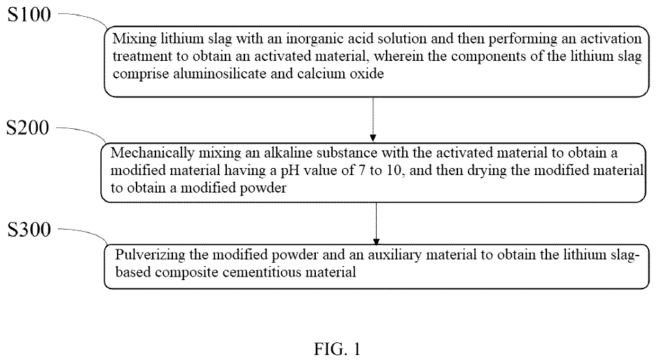

The process flow diagram of a preparation method of a lithium slag-based composite cementitious material of the present disclosure is shown in FIG. 1, including the following steps:

S100, mixing lithium slag with an inorganic acid solution and then performing an activation treatment to obtain an activated material, wherein the components of the lithium slag comprise aluminosilicate and calcium oxide.

In this step, when mixing the lithium slag with the inorganic acid solution and then performing the activation treatment, the inorganic acid solution can react with the lithium slag, so that inert aluminosilicate can be activated and depolymerized to generate active aluminate and silicate, which can improve the pozzolanic activity for the lithium slag. Moreover, impurity elements such as aluminum, calcium, and the like in the lithium slag can also be utilized in situ as retarders and activators. Therefore, the activated material obtained in this step is a powder with excellent reactivity. Moreover, in this step, the acid in the acid solution is generally an inorganic acid. This is because an organic acid does not fully dissociate in water, and the organic groups present in the solution can adversely affect the compressive strength and service life of the resulting product. Specifically, the acid in the inorganic acid solution is generally an industrial by-product inorganic acid, and may specifically be at least one of hydrogen chloride, sulfuric acid, or nitric acid. However, in practical operation, since hydrogen chloride contains chloride ions, which can adversely affect the compressive strength and service life of the resulting product. Therefore, at least one of sulfuric acid or nitric acid is generally selected. Furthermore, the hydrogen ion concentration in the inorganic acid solution is generally not less than 5 mol/L, otherwise may not easy to activate the lithium slag, and the maximum hydrogen ion concentration typically does not exceed 36 mol/L. Additionally, the mass of the inorganic acid solution generally accounts for 5% to 20% of the mass of the lithium slag, for example, it may be 5%, 8%, 10%, 15%, 20%, etc., or within a range formed by any two of the above-mentioned values.

The molecular formula of the aluminosilicate in the lithium slag can be represented as xAl₂O₃·ySiO₂. In some embodiments of the present disclosure, based on the mass of the lithium slag, the aluminum oxide content is typically in the range of 10% to 20%, and may specifically be 10%, 12%, 15%, 20%, etc., or within a range formed by any two of the above-mentioned values; and the silicon dioxide content is typically in the range of 30% to 60%, and may specifically be 30%, 40%, 50%, 60%, or within a range formed by any two of the above-mentioned values. Furthermore, in the present disclosure, based on the mass of the lithium slag, the calcium oxide content is typically in the range of 5% to 30%, and may specifically be 5%, 10%, 15%, 20%, 25%, 30%, etc., or within a range formed by any two of the above-mentioned values. The type of the lithium slag is generally at least one of lepidolite smelting slag or spodumene smelting slag. As an example, in the embodiments of the present disclosure, the lithium slag is consistently from the same batch. Moreover, based on mass fraction of the lithium slag, the content of the aluminum oxide is 12%, the content of the silicon dioxide is 40%, and the content of the calcium oxide is 25%. Additionally, in practical production, the components of the lithium slag generally include not only the aluminum oxide and the silicon dioxide but also other components such as sulfur trioxide, which accounts for 5% to 25%. Taking sulfur trioxide as an example, it can promote the formation of ettringite cementitious minerals, thereby enhancing its compressive strength. In the present disclosure, the content of the sulfur trioxide is 18%.

Furthermore, in some embodiments of the present disclosure, this step generally involves gradually adding the inorganic acid solution to the lithium slag while mixing thoroughly, which helps to fully enhance the activity of the lithium slag. The activation treatment generally employs a mechanical activation method, utilizing at least one of ball mills, vertical mills, mixers, rod mills, or column mills, and the like. Moreover, during the activation treatment, a first activation stage and a second activation stage are typically included, thereby enabling the lithium slag to achieve higher reactivity. During the first activation stage, the rotational speed is in the range of 50 r/min to 150 r/min, and the grinding duration is in the range of 30 min to 60 min. For example, in the first activation stage, the rotational speed may be 50 r/min, 70 r/min, 90 r/min, 110 r/min, 130 r/min, 150 r/min, or within a range formed by any two of the above-mentioned values; the grinding duration may be 30 min, 40 min, 50 min, 60 min, etc., or within a range formed by any two of the above-mentioned values. During the second activation stage, the rotational speed is in the range of 250 r/min to 400 r/min, and the duration is in the range of 30 min to 90 min. For example, in the second activation stage, the rotational speed may be 250 r/min, 300 r/min, 350 r/min, 400 r/min, etc., or within a range formed by any two of the above-mentioned values; the grinding duration may be 30 min, 50 min, 70 min, 90 min, etc., or within a range formed by any two of the above-mentioned values.

S200, mechanically mixing an alkaline substance with the activated material to obtain a modified material having a pH value of 7 to 10, and then drying the modified material to obtain a modified powder.

In this step, excess hydrogen ions in the activated material can be neutralized, rendering the modified material neutral or weakly alkaline, which is beneficial for enhancing the compressive strength and the service life of the resulting product. In some embodiments of the present disclosure, the alkaline substance includes alkaline solid waste, mineral, alkaline reagent, and the like, specifically including but not limited to at least one of carbide slag, steel slag, magnesium slag, calcium hydroxide, or sodium hydroxide, etc. In practical operation, considering cost and environmental factors, calcium-based solid waste (such as carbide slag and steel slag) is generally used as the alkaline substance and mixed with the activated material to produce the modified material.

Additionally, in some embodiments of the present disclosure, the step of mechanically mixing the alkaline substance with the activated material generally includes two sequential stages: a first mechanical mixing stage and a second mechanical mixing stage. Specifically, during the first mechanical mixing stage, the rotational speed is in the range of 100 r/min to 200 r/min, the duration is in the range of 60 min to 90 min, and the mass of the alkaline substance added accounts for 5% to 20% of the mass of the lithium slag. During the second mechanical mixing stage, the rotational speed is in the range of 250 r/min to 400 r/min, the duration is in the range of 30 min to 60 min, and the mass of the alkaline substance added accounts for 2% to 4% of the mass of the lithium slag.

During the first mechanical mixing stage, with its extended duration and lower rotational speed, the alkaline substance primarily functions to neutralize excess hydrogen ions. During the neutralization process, mineral phases such as calcium sulfate, aluminum sulfate, and the like can be formed, providing active raw materials for the subsequent formation of cementitious mineral phases including ettringite, calcium silicate hydrate, and the like. During the second mechanical mixing stage, characterized by shorter duration and higher rotational speed, the alkaline substance further decomposes undissociated aluminosilicate in the lithium slag to form the active aluminate and the active silicate. This further enhances the activity of the modified lithium slag, which not only facilitates an increased incorporation ratio of the lithium slag content in the lithium slag-based composite cementitious material but also prevents the consumption of the activators typical observed in conventional alkali activation mechanisms.

S300, pulverizing the modified powder and an auxiliary material to obtain the lithium slag-based composite cementitious material.

In this step, as elements such as aluminum, silicon, sulfur, calcium and the like in the modified powder have been inductively activated, the modified powder exhibits high reactivity. Consequently, the lithium slag-based composite cementitious material with high compressive strength can be formed without requiring large amounts of the auxiliary material. For example, in some embodiments of the present disclosure, the mass of the auxiliary material added may account for 40% to 60% of the mass of the lithium slag in step S100.

Additionally, in some embodiments of the present disclosure, the auxiliary material includes but is not limited to at least one of slag, clinker, fly ash, or gypsum, particularly the slag and the clinker, which can form a higher strength cementitious composite material when combined with the modified powder. However, due to the relatively high cost of the clinker, in practical operation, considering cost factors, the auxiliary material is typically a combination of the above-mentioned four substances.

Additionally, during practical production, the auxiliary material is generally added in two batches during the pulverization process. Specifically, the first batch includes the fly ash and the gypsum to ensure components sufficient, such as aluminum, silicon, calcium, and sulfur, thereby maintaining high reactivity in the system. The second batch of the slag and the clinker can generate the alkaline substance to activate the aluminosilicate in the system, simultaneously producing the highly reactive cementitious phases such as dicalcium silicate, tricalcium silicate, calcium aluminosilicate, and the like. When hydrated with water, high-strength composite cementitious phases such as ettringite and calcium silicate hydrate can be generated. This significantly enhances the utilization rate of solid waste while reducing the consumption of the clinker, the cement, and the activators.

During the first pulverization stage, the rotational speed is typically in the range of 200 r/min to 300 r/min, and the duration is in the range of 30 min to 60 min. Specifically, the rotational speed may be any one of 200 r/min, 250 r/min, 300 r/min, etc., or within a range formed by any two of the above-mentioned values; and the duration may be any one of 30 min, 40 min, 50 min, 60 min, etc., or within a range formed by any two of the above-mentioned values. The respective masses of the fly ash and the gypsum added each account for 5% to 20% of the mass of the lithium slag, for example, any one of 5%, 10%, 15%, 20%, etc., or within a range formed by any two of the above-mentioned values.

During the second pulverization stage, the rotational speed is typically in the range of 100 r/min to 200 r/min, and the duration is in the range of 60 min to 90 min. Specifically, the rotational speed may be any one of 100 r/min, 150 r/min, 200 r/min, or within a range formed by any two of the above-mentioned values; and the duration may be any one of 60 min, 70 min, 80 min, 90 min, etc., or within a range formed by any two of the above-mentioned values. The mass of the slag added generally accounts for 10% to 30% of the mass of the lithium slag, and may specifically be any one of 10%, 15%, 20%, 25%, 30%, etc., or within a range formed by any two of the above-mentioned values. The mass of the clinker added generally accounts for 2% to 10% of the mass of the lithium slag, and may specifically be any one of 2%, 4%, 6%, 8%, 10%, etc., or within a range formed by any two of the above-mentioned values.

The lithium slag-based composite cementitious material produced by the preparation method of the present disclosure is an active powder. Unlike traditional geopolymers, the lithium slag-based composite cementitious material of the present disclosure offers broader applicability and a larger transport radius, effectively making it an excellent substitute for Grade 52.5 and even Grade 62.5 cement. It can be widely applied in building materials, concrete products, ecological restoration, mine backfilling, roadbed materials, and the like. Furthermore, the lithium slag-based composite cementitious material obtained by the preparation method of the present disclosure exhibits compressive strength consistent with the corresponding regression equation, enabling the attainment of desired mechanical properties by adjusting material parameters.

The following describes the features and performance of the present disclosure in further detail with reference to the embodiments. In the specific embodiments of the present disclosure, unless otherwise specified, pH values and hydrogen ion concentrations are measured at 25° C. Additionally, the compressive strength tests in the present disclosure are conducted in accordance with the GB50107 standard.

### Example 1

The present example provides a lithium slag-based composite cementitious material and a preparation method thereof. The preparation method specifically included the following steps:

(1) A sulfuric acid solution with a hydrogen ion concentration of 8 mol/L was uniformly mixed with the lithium slag to obtain a mixture, and the mixture was then subjected to mechanical activation treatment to produce an activated material, wherein the mass of the sulfuric acid solution accounted for 10% of the mass of the lithium slag. The activation treatment included a first activation stage and a second activation stage, wherein the rotational speed in the first activation stage was 150 r/min, with a ball milling time of 60 min; and the rotational speed in the second activation stage was 400 r/min, with a ball milling time of 90 min.

(2) Carbide slag was gradually added in two batches to the activated powder from step (1) and mechanically mixed. After thorough mixing, a modified material with a pH value of 7 was obtained, which was then dried to yield a modified powder. The mass of the first batch of the carbide slag accounted for 4% of the mass of the lithium slag, and the mechanical mixing was performed at an agitation speed of 200 r/min for 90 min. The mass of the second batch of the carbide slag accounted for 2.5% of the mass of the lithium slag, and the mechanical mixing was conducted at an agitation speed of 400 r/min for 60 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 300 r/min, the duration was 60 min, and the auxiliary material was fly ash and gypsum, with their masses accounting for 10% and 10%, respectively, of the mass of the lithium slag in step (1). During the second pulverization stage, the rotational speed was 200 r/min, the duration was 90 min, and the auxiliary material was slag and clinker, with their masses accounting for 25% and 6%, respectively, of the mass of the lithium slag in step (1).

The lithium slag-based composite cementitious material of this example achieves a compressive strength of 25.48 MPa at 3 days, 46.54 MPa at 7 days, and 72.83 MPa at 28 days.

### Example 2

The present example provides a lithium slag-based composite cementitious material and a preparation method thereof. The preparation method specifically included the following steps:

(1) A sulfuric acid solution with a hydrogen ion concentration of 5 mol/L was uniformly mixed with the lithium slag to obtain a mixture, and the mixture was then subjected to mechanical activation treatment to produce activated material, wherein the mass of the sulfuric acid solution accounted for 20% of the mass of the lithium slag. The activation treatment included a first activation stage and a second activation stage, wherein the rotational speed in the first activation stage was 100 r/min, with a ball milling duration of 50 min; and the rotational speed in the second activation stage was 300 r/min, with a ball milling duration of 75 min.

(2) Carbide slag was gradually added in two batches to the activated powder from step (1) and mechanically mixed. After thorough mixing, a modified material with a pH value of 8 was obtained, which was then dried to yield a modified powder. The mass of the first batch of the carbide slag accounted for 4% of the mass of the lithium slag, and the mechanical mixing was performed at an agitation speed of 200 r/min for 90 min. The mass of the second batch of the carbide slag accounted for 3% of the mass of the lithium slag, and the mechanical mixing was conducted at an agitation speed of 350 r/min for 40 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 200 r/min, the duration was 60 min, and the auxiliary material was fly ash and gypsum, with their masses accounting for 10% and 15%, respectively, of the mass of the lithium slag in step (1). During the second pulverization stage, the rotational speed was 100 r/min, the duration was 90 min, and the auxiliary material was slag and clinker, with their masses accounting for 20% and 4%, respectively, of the mass of the lithium slag in step (1).

The lithium slag-based composite cementitious material of this example achieves a compressive strength of 22.47 MPa at 3 days, 41.28 MPa at 7 days, and 67.51 MPa at 28 days.

### Example 3

The present example provides a lithium slag-based composite cementitious material and a preparation method thereof. The preparation method specifically included the following steps:

(1) A sulfuric acid solution with a hydrogen ion concentration of 36 mol/L was uniformly mixed with the lithium slag to obtain a mixture, and the mixture was then subjected to mechanical activation treatment to produce an activated material, wherein the mass of the sulfuric acid solution accounted for 2% of the mass of the lithium slag. The activation treatment included a first activation stage and a second activation stage, wherein the rotational speed in the first activation stage was 150 r/min with a ball milling duration of 60 min; and the rotational speed in the second activation stage was 400 r/min with a ball milling duration of 90 min.

(2) Carbide slag was gradually added in two batches to the activated powder from step (1) and mechanically mixed. After thorough mixing, a modified material with a pH value of 10 was obtained, which was then dried to yield a modified powder. The mass of the first batch of the carbide slag accounted for 3.5% of the mass of the lithium slag, and the mechanical mixing was performed at an agitation speed of 200 r/min for 90 min. The mass of the second batch of the carbide slag accounted for 2% of the mass of the lithium slag, and the mechanical mixing was conducted at an agitation speed of 400 r/min for 60 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 250 r/min, the duration was 40 min, and the auxiliary material was fly ash and gypsum, with their masses accounting for 5% and 10%, respectively, of the mass of the lithium slag in step (1). During the second pulverization stage, the rotational speed was 200 r/min, the duration was 75 min, and the auxiliary material was slag and clinker, with their masses accounting for 15% and 10%, respectively, of the mass of the lithium slag in step (1).

The lithium slag-based composite cementitious material of this example achieves a compressive strength of 20.38 MPa at 3 days, 38.76 MPa at 7 days, and 63.71 MPa at 28 days.

### Example 4

The present example provides a lithium slag-based composite cementitious material and a preparation method thereof. The preparation method specifically included the following steps:

(1) A sulfuric acid solution with a hydrogen ion concentration of 15 mol/L was uniformly mixed with the lithium slag to obtain a mixture, and the mixture was then subjected to mechanical activation treatment to produce an activated material, wherein the mass of the sulfuric acid solution accounted for 6% of the mass of the lithium slag. The activation treatment included a first activation stage and a second activation stage, wherein the rotational speed in the first activation stage was 140 r/min with a ball milling duration of 45 min; and the rotational speed in the second activation stage was 330 r/min with a ball milling duration of 60 min.

(2) Carbide slag was gradually added in two batches to the activated powder from step (1) and mechanically mixed. After thorough mixing, a modified material with a pH value of 7 was obtained, which was then dried to yield a modified powder. The mass of the first batch of the carbide slag accounted for 5% of the mass of the lithium slag, and the mechanical mixing was performed at an agitation speed of 180 r/min for 70 min. The mass of the second batch of the carbide slag accounted for 2.5% of the mass of the lithium slag, and the mechanical mixing was conducted at an agitation speed of 360 r/min for 40 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 270 r/min, the duration was 35 min, and the auxiliary material was fly ash and gypsum, with their masses accounting for 5% and 15%, respectively, of the mass of the lithium slag in step (1). During the second pulverization stage, the rotational speed was 180 r/min, the duration was 80 min, and the auxiliary material was slag and clinker, with their masses accounting for 10% and 10%, respectively, of the mass of the lithium slag in step (1).

The lithium slag-based composite cementitious material of this example achieves a compressive strength of 23.79 MPa at 3 days, 43.84 MPa at 7 days, and 70.68 MPa at 28 days.

### Example 5

The present example provides a lithium slag-based composite cementitious material and a preparation method thereof. The preparation method specifically included the following steps:

(1) A sulfuric acid solution with a hydrogen ion concentration of 25 mol/L was uniformly mixed with the lithium slag to obtain a mixture, and the mixture was then subjected to mechanical activation treatment to produce activated material, wherein the mass of the sulfuric acid solution accounted for 3.5% of the mass of the lithium slag. The activation treatment included a first activation stage and a second activation stage, wherein the rotational speed in the first activation stage was 110 r/min with a ball milling duration of 35 min; and the rotational speed in the second activation stage was 360 r/min with a ball milling duration of 55 min.

(2) Carbide slag was gradually added in two batches to the activated powder from step (1) and mechanically mixed. After thorough mixing, a modified material with a pH value of 7 was obtained, which was then dried to yield a modified powder. The mass of the first batch of the carbide slag accounted for 6% of the mass of the lithium slag, and the mechanical mixing was performed at an agitation speed of 160 r/min for 85 min. The mass of the second batch of the carbide slag accounted for 2% of the mass of the lithium slag, and the mechanical mixing was conducted at an agitation speed of 340 r/min for 55 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 270 r/min, the duration was 35 min, and the auxiliary material was fly ash and gypsum, with their masses accounting for 10% and 6%, respectively, of the mass of the lithium slag in step (1). During the second pulverization stage, the rotational speed was 180 r/min, the duration was 80 min, and the auxiliary material was slag and clinker, with their masses accounting for 25% and 6%, respectively, of the mass of the lithium slag in step (1).

The lithium slag-based composite cementitious material of this example achieves a compressive strength of 21.37 MPa at 3 days, 41.52 MPa at 7 days, and 69.46 MPa at 28 days.

### Example 6

The present example provides a lithium slag-based composite cementitious material and a preparation method thereof. The preparation method specifically included the following steps:

(1) A sulfuric acid solution with a hydrogen ion concentration of 12 mol/L was uniformly mixed with the lithium slag to obtain a mixture, and the mixture was then subjected to mechanical activation treatment to produce an activated material, wherein the mass of the sulfuric acid solution accounted for 7% of the mass of the lithium slag. The activation treatment included a first activation stage and a second activation stage, wherein the rotational speed in the first activation stage was 125 r/min with a ball milling duration of 45 min; and the rotational speed in the second activation stage was 390 r/min with a ball milling duration of 70 min.

(2) Carbide slag was gradually added in two batches to the activated powder from step (1) and mechanically mixed. After thorough mixing, a modified material with a pH value of 7 was obtained, which was then dried to yield a modified powder. The mass of the first batch of the carbide slag accounted for 4.5% of the mass of the lithium slag, and the mechanical mixing was performed at an agitation speed of 170 r/min for 65 min. The mass of the second batch of the carbide slag accounted for 2.5% of the mass of the lithium slag, and the mechanical mixing was conducted at an agitation speed of 390 r/min for 30 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 280 r/min, the duration was 40 min, and the auxiliary material was fly ash and gypsum, with their masses accounting for 5% and 10%, respectively, of the mass of the lithium slag in step (1). During the second pulverization stage, the rotational speed was 200 r/min, the duration was 60 min, and the auxiliary material was slag and clinker, with their masses accounting for 30% and 3%, respectively, of the mass of the lithium slag in step (1).

The lithium slag-based composite cementitious material of this example achieves a compressive strength of 23.64 MPa at 3 days, 43.95 MPa at 7 days, and 71.82 MPa at 28 days.

### Example 7

The present example provides a lithium slag-based composite cementitious material and preparation method thereof. The preparation method specifically included the following steps:

(1) A nitric acid solution with a hydrogen ion concentration of 10 mol/L was uniformly mixed with the lithium slag to obtain a mixture, and the mixture was then subjected to mechanical activation treatment to produce an activated material, wherein the mass of the nitric acid solution accounted for 8% of the mass of the lithium slag. The activation treatment included a first activation stage and a second activation stage, wherein the rotational speed in the first activation stage was 140 r/min with a ball milling duration of 35 min; and the rotational speed in the second activation stage was 345 r/min with a ball milling duration of 80 min.

(2) Carbide slag was gradually added in two batches to the activated powder from step (1) and mechanically mixed. After thorough mixing, a modified material with a pH value of 7 was obtained, which was then dried to yield a modified powder. The mass of the first batch of the carbide slag accounted for 5% of the mass of the lithium slag, and the mechanical mixing was performed at an agitation speed of 165 r/min for 60 min. The mass of the second batch of the carbide slag accounted for 2% of the mass of the lithium slag, and the mechanical mixing was conducted at an agitation speed of 330 r/min for 40 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 260 r/min, the duration was 80 min, and the auxiliary material was fly ash and gypsum, with their masses accounting for 5% and 25%, respectively, of the mass of the lithium slag in step (1). During the second pulverization stage, the rotational speed was 175 r/min, the duration was 45 min, and the auxiliary material was slag and clinker, with their masses accounting for 15% and 7%, respectively, of the mass of the lithium slag in step (1).

The lithium slag-based composite cementitious material of this example achieves a compressive strength of 20.92 MPa at 3 days, 41.58 MPa at 7 days, and 69.38 MPa at 28 days.

### Example 8

The present example provides a lithium slag-based composite cementitious material and a preparation method thereof. The preparation method specifically included the following steps:

(1) A nitric acid solution with a hydrogen ion concentration of 12 mol/L was uniformly mixed with the lithium slag to obtain a mixture, and the mixture was then subjected to mechanical activation treatment to produce activated material, wherein the mass of the nitric acid solution accounted for 6% of the mass of the lithium slag. The activation treatment included a first activation stage and a second activation stage, wherein the rotational speed in the first activation stage was 100 r/min with a ball milling duration of 50 min; and the rotational speed in the second activation stage was 380 r/min with a ball milling duration of 85 min.

(2) Carbide slag was gradually added in two batches to the activated powder from step (1) and mechanically mixed. After thorough mixing, a modified material with a pH value of 7 was obtained, which was then dried to yield a modified powder. The mass of the first batch of the carbide slag accounted for 3.5% of the mass of the lithium slag, and the mechanical mixing was performed at an agitation speed of 185 r/min for 75 min. The mass of the second batch of the carbide slag accounted for 4% of the mass of the lithium slag, and the mechanical mixing was conducted at an agitation speed of 360 r/min for 50 min.

(3) The modified powder and an auxiliary material were pulverized to obtain the lithium slag-based composite cementitious material. The pulverization included a first pulverization stage and a second pulverization stage in sequence. During the first pulverization stage, the rotational speed was 280 r/min, the duration was 65 min, and the auxiliary material was fly ash and gypsum, with their masses accounting for 5% and 30%, respectively, of the mass of the lithium slag in step (1). During the second pulverization stage, the rotational speed was 180 r/min, the duration was 35 min, and the auxiliary material was slag and clinker, with their masses accounting for 20% and 5%, respectively, of the mass of the lithium slag in step (1).

The lithium slag-based composite cementitious material of this example achieves a compressive strength of 22.58 MPa at 3 days, 42.79 MPa at 7 days, and 72.17 MPa at 28 days.

### Example 9

The present example provides a lithium slag-based composite cementitious material and a preparation method thereof. Compared with Example 1, the main distinction in the preparation method was the omission of the fly ash in step (3).

The lithium slag-based composite cementitious material of this example achieves a compressive strength of 17.85 MPa at 3 days, 31.78 MPa at 7 days, and 57.48 MPa at 28 days. Compared to Example 1, its strength has decreased due to the absence of fly ash, which on one hand leads to poor flowability of the system, poor mixing effect, and uneven system; and on the other hand, the lack of aluminum and silicon resources in fly ash would affect the formation of ettringite cementitious mineral phases, leading to a deterioration in the performance of cementitious materials.

### Example 10

The present example provides a lithium slag-based composite cementitious material and a preparation method thereof. Compared with Example 1, the main distinction in the preparation method was the omission of the clinker in step (3).

The lithium slag-based composite cementitious material of this example achieves a compressive strength of 18.72 MPa at 3 days, 34.35 MPa at 7 days, and 55.89 MPa at 28 days. Compared with example 1, the strength of the material in this example is reduced. This is due to the presence of highly active minerals such as dicalcium silicate, calcium aluminate, calcium hydroxide and the like in the clinker. Without the induction effect of these highly active minerals, the hydration reaction lacks key raw materials for forming cementitious products like calcium silicate hydrate, ettringite and the like, consequently leading to poor performance of the cementitious material.

### Comparative Example 1

The present comparative example provides a lithium slag-based composite cementitious material and a preparation method thereof. Compared with Example 1, the main distinction in the preparation method was the omission of the acid solution in step (1), with direct mechanical activation treatment being performed instead.

The lithium slag-based composite cementitious material of the present comparative example achieves a compressive strength of 9.85 MPa at 3 days, 15.74 MPa at 7 days, and 27.32 MPa at 28 days.

In this comparative example, the ball milling process was conducted without adding the inorganic acid, the aluminosilicate structure of the lithium slag remained unchanged, and its reactivity was unchanged. Strength properties could only be enhanced through the hydration of the slag and the clinker, resulting in poor performance of the cementitious material.

### Comparative Example 2

The present comparative example provides a lithium slag-based composite cementitious material and a preparation method thereof. Compared with Example 1, the primary distinction in the procedure was that, after obtaining the activated material through acid solution activation treatment, step (2) was omitted, and the activated material was directly dried and mixed with the auxiliary material.

The lithium slag-based composite cementitious material of the present comparative example achieves a compressive strength of 12.74 MPa at 3 days, 18.63 MPa at 7 days, and 31.46 MPa at 28 days.

In this comparative example, the activated material obtained in step (1) was not subjected to neutralization treatment, causing most of the highly reactive slag and clinker to participate in neutralization reactions. The highly active components in the clinker and slag were destroyed, leading to poor hydration performance occurred in subsequent stages, resulting in poor performance of the cementitious material.

### Comparative Example 3

The present comparative example provides a lithium slag-based composite cementitious material and a preparation method thereof. Compared with Example 1, the primary distinction in the procedure was that, after mixing the alkaline substance such as carbide slag with the activated material in step (2), the resulting modified material had a pH value of 11.

The lithium slag-based composite cementitious material of the present comparative example achieves a compressive strength of 14.26 MPa at 3 days, 20.36 MPa at 7 days, and 34.85 MPa at 28 days.

In this comparative example, the activated slag obtained in step (1) was subjected to neutralization treatment, but excessive addition of the alkaline substance caused the system to be overly alkaline with excessively high active calcium content. This was prone to cause expansion, leading to subsequent material cracking and resulting in poor performance of the cementitious material.

In summary, the preparation method provided in the present disclosure utilizes the lithium slag as the raw material. By employing protonic acid activation coupled with mechanical processing, it achieves the depolymerization and activation of the inert aluminosilicate, thereby generating the active aluminate and silicate. This approach not only enhances the pozzolanic activity of the lithium slag, but also enables in-situ utilization of the impurity elements such as aluminum and calcium to form aluminum-calcium based chemical activators, thereby addressing the problem of low reactivity in the lithium slag. By adding calcium-based solid waste in batches, on one hand, it neutralizes excess sulfuric acid to ensure the stability of the cementitious system; on the other hand, it further promotes the deep dissociation of the aluminosilicate to enhance reactivity, thereby achieving a stable cementitious system and a significantly increase of the reactivity of the lithium slag. Finally, by adding fly ash, gypsum, slag, and clinker in batches, the system achieves induced activation of the elements such as aluminum, silicon, sulfur, and calcium, and the like to form the cementitious material. The obtained lithium slag-based composite cementitious material can meet the requirements for Grade 52.5 and even Grade 62.5 cement when tested according to standard methods. Concurrently, it eliminates the consumption of the alkali activators, thereby substantially reducing the consumption of the clinker and the cement, shortening the process flow, and lowering manufacturing costs.

The above-mentioned are merely embodiments of the present disclosure and are not intended to limit the scope of protection of the present disclosure. For those skilled in the art, the present disclosure may be subject to various modifications and variations. Any modifications, equivalent substitutions, improvements, etc., made within the spirit and principles of the present disclosure shall be included within the scope of protection of the present disclosure.

What is claimed is:

1. A preparation method of a lithium slag-based composite cementitious material, comprising:
S100, mixing lithium slag with an inorganic acid solution and then performing an activation treatment to obtain an activated material, wherein the components of the lithium slag comprise aluminosilicate and calcium oxide;
S200, mechanically mixing an alkaline substance with the activated material to obtain a modified material having a pH value of 7 to 10, and then drying the modified material to obtain a modified powder; and
S300, pulverizing the modified powder and an auxiliary material to obtain the lithium slag-based composite cementitious material;
wherein the alkaline substance in step S200 comprises at least one of carbide slag, steel slag, magnesium slag, calcium hydroxide, or sodium hydroxide;
the auxiliary material comprises at least one of slag, clinker, fly ash, or gypsum; and the mass of the auxiliary material added accounts for 40% to 60% of the mass of the lithium slag.

2. The preparation method of a lithium slag-based composite cementitious material according to claim 1, wherein based on the mass of the lithium slag, the mass content of aluminum oxide in the aluminosilicate is in the range of 10% to 20%, the mass content of silicon dioxide in the aluminosilicate is in the range of 30% to 60%, and the mass content of the calcium oxide is in the range of 5% to 30%.

3. The preparation method of a lithium slag-based composite cementitious material according to claim 1, wherein the lithium slag comprises at least one of lepidolite smelting slag or spodumene smelting slag.

4. The preparation method of a lithium slag-based composite cementitious material according to claim 1, wherein the preparation method satisfies at least one of the following conditions:
(1) the inorganic acid in the inorganic acid solution comprises at least one of sulfuric acid or nitric acid;
(2) the concentration of hydrogen ion in the inorganic acid solution ranges from 5 mol/L to 36 mol/L; and
(3) the mass of the inorganic acid solution accounts for 5% to 20% of the mass of the lithium slag.

5. The preparation method of a lithium slag-based composite cementitious material according to claim 1, wherein the activation treatment in step S100 is performed using a mechanical activation method.

6. The preparation method of a lithium slag-based composite cementitious material according to claim 1, wherein the step of mechanically mixing the alkaline substance and the activated material sequentially comprises a first mechanical mixing and a second mechanical mixing;
the rotational speed of the first mechanical mixing ranges from 100 r/min to 200 r/min, with a duration of 60 min to 90 min, and the mass of the alkaline substance added accounts for 5% to 20% of the mass of the lithium slag; and the rotational speed of the second mechanical mixing ranges from 250 r/min to 400 r/min, with a duration of 30 min to 60 min, and the mass of the alkaline substance added accounts for 2% to 4% of the mass of the lithium slag.

7. The preparation method of a lithium slag-based composite cementitious material according to claim 1, wherein the preparation method satisfies at least one of the following conditions:
(1) the gypsum comprises at least one of desulfurized gypsum, anhydrite, phosphogypsum, or fluorogypsum;
(2) the fly ash comprises at least one of fluidized bed fly ash or pulverized coal furnace fly ash; and
(3) the clinker comprises at least one of Portland clinker, aluminate clinker, or sulfoaluminate clinker.

8. A lithium slag-based composite cementitious material, produced by the preparation method of a lithium slag-based composite cementitious material according to claim 1.
